(19) United States
(12) Patent Application Publication
(10) Pub. No.: US 2007/0266157 A1
(43) Pub. Date: Nov. 15, 2007

(54) REDUCING COLLISIONS IN WIRELESS SYSTEMS

(75) Inventors: Ariton E. XHAFA, Plano, TX (US); Shantanu KANGUDE, Dallas, TX (US); Jing-Fei REN, Plano, TX (US); Artur ZAKS, Modiin (IL); Manish AIRY, New Delhi (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/747,665

(22) Filed: May 11, 2007

Related U.S. Application Data
(60) Provisional application No. 60/747,052, filed on May 11, 2006.
(60) Provisional application No. 60/803,456, filed on May 30, 2006.
(60) Provisional application No. 60/804,609, filed on Jun. 13, 2006.
(60) Provisional application No. 60/804,617, filed on Jun. 13, 2006.

(51) Int. Cl. G06F 15/173

(52) U.S. Cl. 709/225

(57) ABSTRACT

A device comprising processing logic and transceiver logic coupled to the processing logic. The data is transmitted and received on at least one of a first channel and a second channel. The processing logic determines whether the first channel has been idle for at least a predetermined length of time and determines whether the second channel has been idle for at least another predetermined length of time. Based on these determinations, the transceiver logic transmits data to another device on one or both of the first and second channels.

### CROSS-REFERENCE TO RELATED APPLICATION

The present application claims priority to U.S. Provisional Patent Application No. 60/747,052, filed on May 11, 2006 (Attorney Docket No. TI-62552PS); U.S. Provisional Patent Application No. 60/803,456, filed on May 30, 2006 (Attorney Docket No. TI-62PS); U.S. Provisional Patent Application No. 60/804,609 (Attorney Docket No. TI-62386PS), filed on Jun. 13, 2006; and U.S. Provisional Patent Application No. 60/804,617, filed on Jun. 13, 2006 (Attorney Docket No. TI-62501PS), all of which are hereby incorporated herein by reference.

### BACKGROUND

The 802.11 standards comprise a plurality of standards that are usable in Wireless Local Area Network (WLAN) systems. Various standards fall within the 802.11 family, including 802.11a, 802.11b, 802.11 g and 802.11n. Members (e.g., access points (APs) and stations (STAs)) of a WLAN implementing an 802.11 standard generally communicate with each other by wirelessly transmitting data in channels with bandwidths of 20 MHz.

In some cases, however, members of a WLAN may communicate with each other using multiple channels of 20 MHz each, effectively transmitting data in a “super channel” with 40 MHz of bandwidth. One of the 20 MHz channels is referred to as the “control” channel, which carries control information vital to the operation of the WLAN, and the other 20 MHz channel is referred to as the “extension” channel, which carries additional, miscellaneous data. Data transmissions on a single 20 MHz channel encounter few, if any, collisions with data from other wireless devices. However, data transmissions sent on 40 MHz “super channels” frequently encounter collisions with data from other wireless devices. These collisions often occur because other many wireless devices attempt to use the extension channel.

### SUMMARY

Accordingly, there are disclosed herein various techniques for reducing or even eliminating data collisions on wireless network channels. An illustrative embodiment includes a device comprising processing logic and transceiver logic coupled to the processing logic. The data is transmitted and received on at least one of a first channel and a second channel. The processing logic determines whether the first channel has been idle for at least a predetermined length of time and determines whether the second channel has been idle for at least another predetermined length of time. Based on these determinations, the transceiver logic transmits data to another device on one or both of the first and second channels.

Another illustrative embodiment includes a device comprising circuit logic, where the data is transmitted and received on at least one of a control channel and an extension channel. If the circuit logic determines that the control channel has been idle for at least a predetermined length of time and that the extension channel has been idle for at least another predetermined length of time, the circuit logic simultaneously transmits data to the another device via both the control and extension channels.

Yet another illustrative embodiment includes a system comprising a first device adapted for wireless communications. The system also includes a second device adapted to transmit data to and receive data from the first device via at least one of a control channel and an extension channel. If the second device determines that the control channel has been idle for at least a predetermined amount of time, the second device transmits data to the first device on the control channel. If the second device determines that the extension channel has been idle for at least another predetermined amount of time, the second device transmits data to the first device on the extension channel.

Yet another illustrative embodiment includes a method that comprises providing a first device and a second device. The method also includes, if the first device determines that a control channel has been idle for at least a predetermined length of time and that an extension channel has been idle for at least a different, predetermined length of time, transmitting data from the first device to the second device on both the control channel and on the extension channel.

### BRIEF DESCRIPTION OF THE DRAWINGS

For a detailed description of exemplary embodiments of the invention, reference will now be made to the accompanying drawings in which:

FIG. 1 shows an illustrative system implementing at least some of the disclosed techniques in accordance with embodiments of the invention;

FIG. 2 shows an illustrative channel used to enable communications between members of the system of FIG. 1, in accordance with embodiments of the invention;

FIG. 3a shows an illustrative block diagram of a member of the system of FIG. 1, in accordance with embodiments of the invention;

FIGS. 3b-3e show illustrative channels used in accordance with preferred embodiments of the invention;

FIG. 3f shows a flow diagram of a method implemented in accordance with embodiments of the invention; and

FIG. 4 shows an illustrative signal configured in accordance with preferred embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “connection” refers to any path via which a signal may pass. For example, the term “connection” includes, without limitation, wires, traces and other types of electrical conductors, optical devices, etc. Also, the terms “control channel” and “extension channel” are defined in accordance with the Institute of Electrical and Electronics Engineers (IEEE) 802.11 protocol (e.g., 802.11n protocol). The terms “control channel” and “extension channel” may be considered substantially equivalent to other terms used in other wireless communication protocols, where the other terms denote wireless channels similar to the control and extension channels. Further, the terms “primary channel,” “first channel,” and “control channel” are related and may be considered equivalent in at least some embodiments. Further still, the terms “secondary channel,” “second channel” and “extension channel” are related and may be considered equivalent in at least some embodiments.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment. For example, although the control and extension channels are described herein as being 20 MHz wide, in some embodiments, the control and extension channels may have different bandwidths. The techniques disclosed herein may be applied to systems having control and extension channels, and/or any other channels, of any suitable bandwidth(s).

Disclosed herein are various techniques by which data transmission collisions on channels in 802.11 wireless networks (e.g., Wireless Local Area Networks (WLANs)) are reduced or even eliminated. The techniques are implemented on various members of a network, including access points (APs), stations (STAs), etc. In at least some embodiments, the technique comprises performing a clear channel assessment (CCA) on the 20 MHz control channel before transmitting data thereupon. Performance of a CCA on the control channel ensures that the control channel is not being used by another wireless device. Likewise, in some such embodiments, the technique comprises performing a CCA on the 20 MHz extension channel before transmitting data thereon to ensure that the extension channel is not being used by another wireless device. Also, in some embodiments, a single CCA is simultaneously performed on both the control and extension channels to ensure that both channels are not being used prior to transmission of data thereupon. Further, in some embodiments, the time frames (transmission opportunities, or TxOPs) within which members of a WLAN are allowed to transmit data on the 40 MHz super channel are regulated to mitigate any undesirable effects of transmitting data on the super channel.

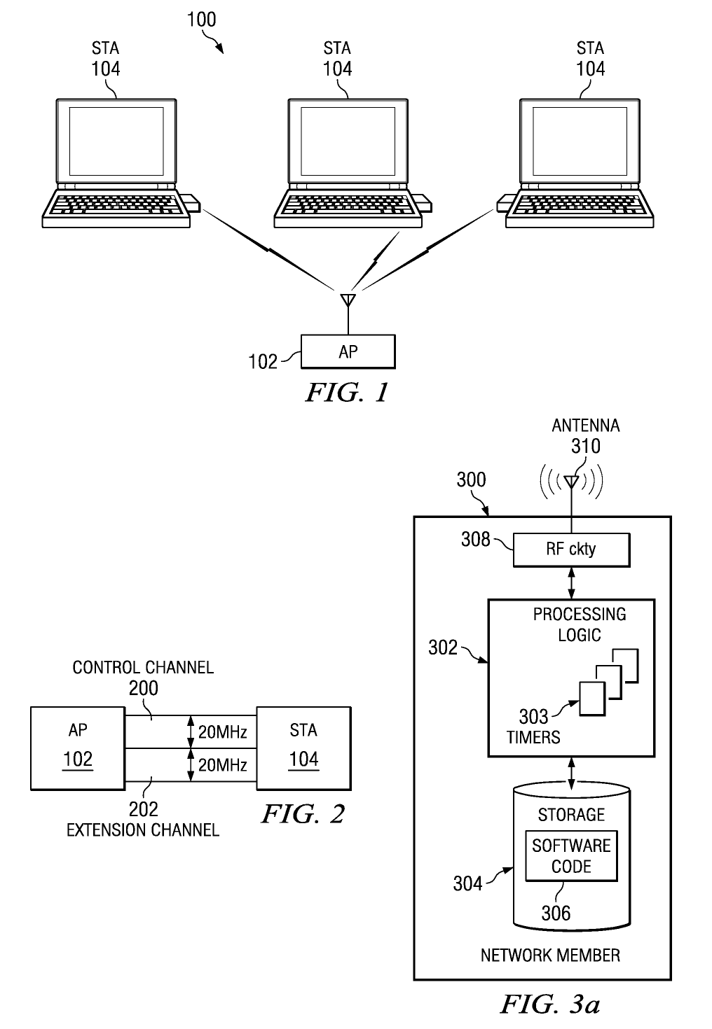

FIG. 1 shows an illustrative network 100 (e.g., a WLAN) comprising an access point (AP) 102 and multiple stations (STAs) 104. Each of the STAs 104 comprises any suitable wireless device, such as a personal computer (PC) or other mobile communication device. For example, in some embodiments, an AP 100 may comprise a wireless access point communicably coupled to an Internet Service Provider (ISP) and the STAs 104 may comprise laptop computers communicably coupled to the AP 100. FIG. 2 shows an illustrative control channel 200 and an illustrative extension channel 202 by which the AP 102 communicates with an STA 104. In at least some embodiments, the channels 200 and 202 are used to transmit data between the AP 102 and multiple STAs 104. As previously explained, the control channel 200 preferably is a 20 MHz-wide channel used to transfer control information vital to the operation of the network 100. Examples of such information include beacons and other control and management messages. The extension channel 202 preferably is a 20 MHz-wide channel used to transfer any suitable information. Together, the control channel 200 and the extension channel 202 may form a “super channel” that has a preferred bandwidth of 40 MHz. As described below, the extension channel 202 is dependent on the control channel 200 in that in at least some embodiments, a member of the network 100 may not transmit data on the extension channel 202 unless that member has control of the control channel 200.

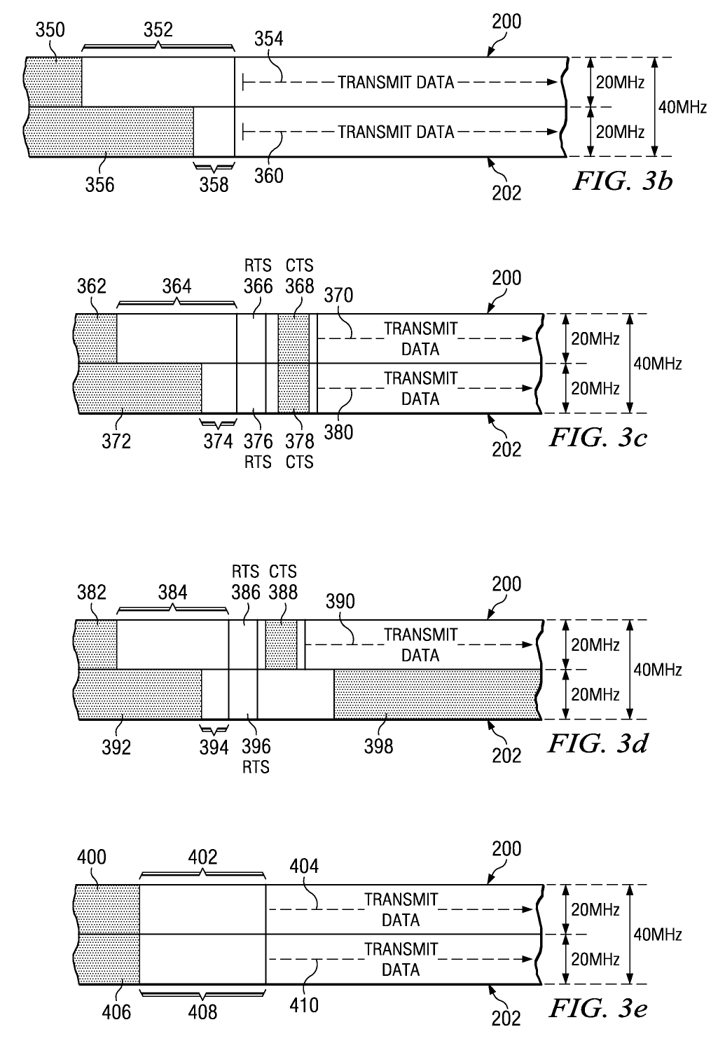

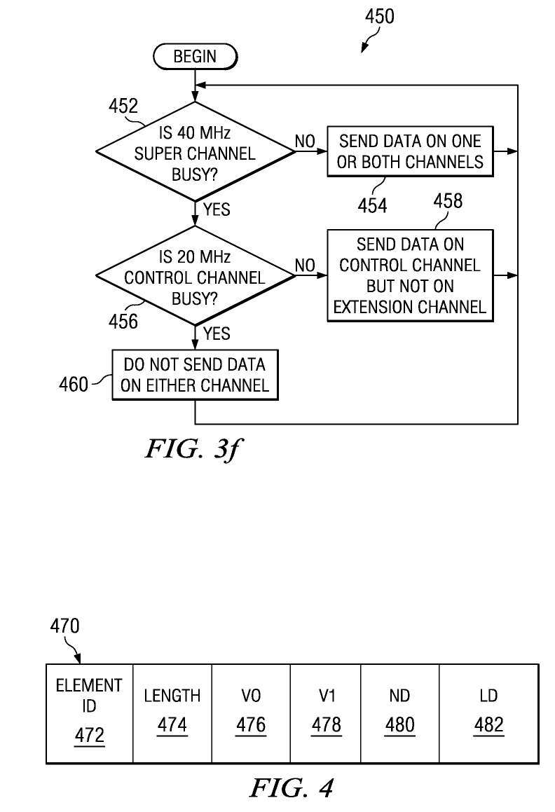

FIG. 3a shows an illustrative block diagram of at least some contents of a member 300 of the network 100. The member 300 may comprise an AP, a STA, or any other suitable wireless device within the network 100. As shown, the member 300 comprises a processing logic 302 including a plurality of incrementing timers 303, a storage 304 including software code 306, RF circuitry (or “transceiver logic”) 308 and an antenna 310. When executed by the processing logic 302, the software code 306 causes the processing logic 302 to perform at least some of the various techniques disclosed herein.

In accordance with various embodiments, the processing logic 302 performs CCAs on both the control channel 200 and the extension channel 202. Specifically, the processing logic 302 monitors each of the channels 200 and 202 to determine when the channels are idle (i.e., when data is not being sent on the channels). If the processing logic 302 determines that one of the channels 200 and 202 is idle, the processing logic 302 resets a timer 303. As long as the channel is idle, the timer 303 continues to increment. If the processing logic 302 determines that the value of the timer 303 has exceeded a predetermined threshold (e.g., programmed by an administrator), the logic 302 “takes control” of the channel by transmitting data on that channel.

For example, the processing logic 302 may monitor the control channel 200 for data transmissions. If no transmissions are detected, the logic 302 resets a timer 303 dedicated to the channel 200. Each time the logic 302 detects a transmission on the channel 200, the logic 302 reset the timer 303. However, if no data transmissions are detected, the timer 303 will continue to increment and will eventually reach or exceed a predetermined threshold stored on the processing logic 302. If this threshold is met or exceeded, the logic 302 determines that the control channel 200 is not being used by any other wireless device and the logic 302 takes control of the channel (e.g., by initiating data transmissions on the channel 200).

Similarly, the processing logic 302 monitors the extension channel 202 for data transmissions. If the logic 302 determines that no data is being transmitted on the extension channel 202, the logic 302 resets a timer 303 dedicated to the channel 202. Each time the logic 302 detects a data transmission on the extension channel 202, the logic 302 resets the dedicated timer 303. However, in the absence of data transmissions on the extension channel 202, the dedicated timer 303 will eventually increment to a value meeting or exceeding a predetermined threshold. If this happens, the processing logic 302 “takes control” of the extension channel 202 by initiating data transmissions on the extension channel 202. In some preferred embodiments, the timer 303 dedicated to the extension channel 202 is not reset unless both the control and extension channels are idle, since the possibility of transmitting data on the extension channel 202 may be dependent upon the possibility of transmitting data on the control channel 200.

In this way, the processing logic 302 can take control of one or both of the channels 200 and 202. If the processing logic 302 takes control of only one of the channels, the logic 302 can transmit data to another wireless device with a bandwidth of 20 MHz. However, if the processing logic 302 is able to take control of both of the channels, the logic 302 can transmit data to another wireless device with a bandwidth of 40 MHz. By waiting for predetermined amounts of time before taking control of the channels 200 and 202 as described above, the logic 302 ensures that no data transmissions from other wireless devices will collide with data transmissions from the logic 302. In this way, collisions are reduced and throughput is positively affected.

FIG. 3b shows an illustrative implementation of this technique. The processing logic 302 monitors the control channel 200 while data transmissions (indicated by numeral 350) are present on the channel. If the logic 302 detects that the channel 200 is idle for a predetermined length of time (numeral 352), the logic 302 takes control of the channel by transmitting data on the channel (numeral 354). Likewise, the logic 302 monitors the extension channel 202 while data transmissions (numeral 356) are present. If the logic 302 detects that the channel 202 is idle for a predetermined length of time (numeral 358), the logic 302 takes control of the channel by transmitting data on the channel (numeral 360). As shown, the predetermined lengths of time 352 and 358 may be different for the control and extension channels 200 and 202. In some embodiments, the predetermined lengths of time described herein include parameters selected from a group that includes point-coordinating function inter-frame space (PIFS), short inter-frame space (SIFS), distributed coordinating function inter-frame space (DIFS), backoff times, etc. Information regarding such parameters is available in the commonly-assigned patent application entitled, “Shared Communications Channel Access in an Overlapping Coverage Environment,” Publication No. 20020120740, incorporated herein by reference. Although the predetermined lengths of time 352 and 358 may or may not be different, the logic 302 may transmit data on the channels 200 and 202 simultaneously, as shown. This is because data transmissions on the 40 MHz super channel may be thought of as whole transmissions occupying a single channel that is 40 MHz wide (instead of as multiple transmissions on two discrete, 20 MHz-wide channels), although the scope of this disclosure is not limited as such.

In some embodiments, the processing logic 302 performs CCAs on the control and extension channels as described above. Specifically, before taking control of the control channel 200, the processing logic 302 ensures that the control channel 200 has been free of data transmissions at least for a predetermined length of time. However, in these embodiments, the processing logic 302 preferably takes control of the extension channel 202 at the same time as it takes control of the control channel 200. As such, the processing logic 302 does not ensure that the extension channel 202 has been idle for a predetermined period of time before taking control of the channel 202. Referring to FIGS. 3a and 3c, the processing logic 302 monitors the control channel 200 while data transmissions are present on the channel (numeral 362). If the processing logic 302 determines that the channel 202 has been idle for a predetermined length of time (numeral 364), the logic 302 transmits a Request-to-Send (RTS) signal 366 on the control channel 200 to an intended destination wireless device. If the destination device receives the RTS 366 and is available to receive data, the destination device sends a response signal to the logic 302 in the form of a Clear-to-Send (CTS) signal 368. The fact that the destination device is able to receive the RTS 366 and send the CTS 368 indicates that the control channel 200 is available for use by the logic 302. Accordingly, the logic 302 takes control of the control channel 200 by initiating data transmissions (numeral 370).

In accordance with at least some preferred embodiments, the processing logic 302 also monitors the extension channel 202 while data transmissions are being transmitted on the channel (numeral 372). If the logic 302 determines that the control channel 200 is idle for the predetermined length of time mentioned above, in addition to sending RTS 366 on channel 200, the logic 302 also sends an RTS 376 on the extension channel 202 if the extension channel 202 is idle (numeral 374) for any length of time. As mentioned, when sending the RTS 376 on channel 202, the processing logic 302 only ensures that the channel 202 is idle. The logic 302 does not ensure that the channel 202 is idle for any specific length of time. In the illustration of FIG. 3c, the destination device receiving the RTS 376 sends back a CTS 378. Upon receiving the CTS 378, the logic 302 initiates transmission of data on the extension channel 202 (numeral 380). In this way, time is not spent determining whether the extension channel 202 is busy. However, as previously explained, in at least some embodiments, the logic 302 does not initiate transmission of data on the extension channel 202 unless the logic 302 has control of the control channel 200. In at least some such embodiments, data transmissions occur simultaneously on the super channel (i.e., on the control and extension channels).

In some embodiments, the processing logic 302 may send an RTS on the control channel 200, receive a CTS and subsequently transmit data on the control channel 200. However, in some such embodiments, despite sending an RTS on the extension channel 202 at the same time as the RTS on the control channel, the logic 302 may not receive a CTS in response to the RTS on the extension channel 202. Specifically, data collisions may occur which prevent the destination device from receiving the RTS on the extension channel. This may occur in such embodiments because, as explained, the logic 302 only ensures that the control channel 200 has been idle for a predetermined length of time. The logic 302 does not ensure that the extension channel 202 has been idle for a predetermined length of time. Thus, because the logic 302 does not receive a CTS in response to its RTS on the extension channel 202, the logic 302 determines that the extension channel is busy and transmits data only on the control channel 200.

This technique is illustrated in FIG. 3d. As shown, the logic 302 monitors the control channel 200 while data transmissions are present (numeral 382). If the logic 302 determines that the control channel 200 has been idle for a predetermined length of time (numeral 384), the logic 302 sends an RTS 386 to a destination wireless device and receives a CTS 388 in return. Receipt of the CTS 388 indicates to the logic 302 that the control channel 200 is available for use, and so the logic 302 takes control of the channel 200 by initiating transmission of data on the control channel 200 (numeral 390).

Still referring to FIG. 3d, the processing logic 302 may also monitor the extension channel 202 for data transmissions (numeral 392). When the processing logic 302 determines that the control channel 200 has been idle for the predetermined length of time, and further when the processing logic 302 determines that the extension channel 202 is idle (numeral 394; not for any specific length of time), the processing logic 302 transmits an RTS not only on the control channel 200, but also on the extension channel 202 (i.e., the RTS 396). However, because the logic 302 did not ensure that the extension channel 202 was idle by waiting for some predetermined length of time prior to sending the RTS 396, data collisions may occur on the extension channel 202 which prevent the RTS 396 from reaching its intended destination device. As such, because the destination device fails to receive the RTS 396, a CTS is not sent to the logic 302. Accordingly, the logic 302 determines that the extension channel 202 is busy, and transmits data only on the 20 MHz control channel 200. Because the processing logic 302 does not take control of the extension channel 202, other wireless devices in the network may transmit data on the extension channel 202 (numeral 398).

In some embodiments, the processing logic 302 may perform a CCA on the entire 40 MHz super channel. Stated otherwise, the logic 302 may simultaneously perform a CCA on each of the channels 200 and 202. Referring to FIG. 3e, the logic 302 may monitor each of the channels 200 and 202 while data transmissions are being sent on the channels (numerals 400 and 406). If the processing logic 302 determines that each of the channels 200 and 202 has been idle for at least a predetermined length of time (numerals 402 and 408), the processing logic 302 takes control of both channels and begins transmitting data (numerals 404 and 410) on the 40 MHz-wide “super channel” comprising both the control channel 200 and the extension channel 202. As previously mentioned, in preferred embodiments, the predetermined lengths of time used to determine whether the channels 200 and 202 are idle (numerals 402 and 408) are substantially the same. Further, in preferred embodiments, the logic 302 takes control of both channels 200 and 202 at substantially the same time. FIG. 3f shows an illustrative flow chart of a method 450 implemented in accordance with these embodiments of the invention. The method 450 begins by determining whether the 40 MHz super channel is busy (e.g., using CCAs) (block 452). If the super channel is not busy, the method 450 comprises sending data on one (preferably the control channel) or both channels (block 454). However, if the super channel is busy, the method 450 comprises determining whether the control channel is busy (block 456). If the control channel is not busy, the method 450 comprises sending data on the control channel but not on the extension channel (block 458). If the control channel is busy, the method 450 comprises refraining from sending data on either the control channel or the extension channel (block 460). This is because the possibility of data transmissions on the extension channel depends on the possibility of data transmissions on the control channel. Stated otherwise, data preferably is not transmitted on the extension channel unless the transmitting device has control of the control channel.

In some cases, transmissions made on a 40-MHz-wide “super channel” can impact network communications in a less-than-desirable way. For example, while sending transmissions on a 40-MHz-wide channel may improve the throughput of the network member performing the transmissions, such transmissions also prevent other network members from sharing the available channel bandwidth. Thus, in accordance with some embodiments, members of the network 100 may be required to limit the time duration of transmissions sent on both the control channel 200 and the extension channel 202 (i.e., all 40 MHz).

FIG. 4 shows a block diagram of a capability element 470 which may be transmitted by various members of the network. The capability element 470 indicates, or “advertises,” the transmission and/or reception capabilities of the network member that sent the element 470. For example, the element 470 may be transmitted by the AP 102 in a beacon signal, indicating to any STA 104 that receives the beacon that, in order to send transmissions to the AP 102, the STA 104 must transmit signals which comply with the parameters contained in the capability element 470. The element 470 may comprise any suitable information, including an indication as to the periods of time during which the AP 102 will accept transmissions from an STA 104 on the 40-MHz-wide super channel. As shown, the illustrative element 470 comprises an element ID 472, an element length 474, a time period limit indicator 476 for voice data (hereinafter “VO 476”), a time period limit indicator 478 for video data (hereinafter “VI 478”), a time period limit indicator 480 for normal priority data (hereinafter “ND 480”), and a time period limit indicator 482 for low priority data (hereinafter “LD 482”).

The element ID 472 comprises any suitable identifier which distinguishes the element 470 from other elements. The element length 474 indicates a length associated with the element 470, because the number of components associated with the element 470 may vary. The VO 476 indicates the period of time within which any voice data transmission simultaneously sent to the AP 102 on both channels 200 and 202 (i.e., on the 40 MHz super channel) must be completed. The VI 478 indicates the period of time within which any video data transmission simultaneously sent to the AP 102 on both channels 200 and 202 must be completed. The ND 480 indicates the period of time within which any best-effort data transmission simultaneously sent to the AP 102 on both channels 200 and 202 must be completed. The LD 482 indicates the period of time within which any background data transmission simultaneously sent to the AP 102 on both channels 200 and 202 must be completed. Additional such indicators for different types of data also may be included within the capability element 470. When a network member, such as an STA 104, receives the element 470, the STA 104 performs 40 MHz transmissions to the AP 102 in accordance with the various time limits indicated in the element 470. In this way, negative effects of undesirably lengthy data transmissions on the 40 MHz super channel are mitigated. In addition to sending such capability elements 470 in beacon signals, an element 470 may be included in probe response signals, association response signals, etc.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A device, comprising:
processing logic; and
transceiver logic coupled to the processing logic and adapted to transmit and receive data, said data transmitted and received on at least one of a first channel and a second channel;
wherein the processing logic determines whether the first channel has been idle for at least a predetermined length of time and determines whether the second channel has been idle for at least another predetermined length of time;
wherein, based on said determinations, the transceiver logic transmits data to another device on one or both of the first and second channels.

2. The device of claim 1, wherein the first channel comprises a control channel and the second channel comprises an extension channel.

3. The device of claim 1, wherein the device comprises a device selected from the group consisting of a wireless access point (AP) and a mobile communication device.

4. The device of claim 1, wherein the transceiver logic implements the IEEE 802.11n standard.

5. The device of claim 1, wherein, if the processing logic determines that said first channel is idle for said predetermined length of time, the transceiver logic transmits a Request-to-Send (RTS) signal on the first channel and transmits another RTS signal on the second channel.

6. The device of claim 5, wherein the device transmits said another RTS on the second channel regardless of whether the second channel has been idle for said another predetermined length of time.

7. The device of claim 1, wherein the processing logic simultaneously determines whether the first channel has been idle for said predetermined length of time and whether the second channel has been idle for said another predetermined length of time.

8. The device of claim 1, wherein said predetermined length of time and said another predetermined length of time are approximately the same.

9. The device of claim 1, wherein the processing logic receives a signal which indicates a time period within which the transceiver logic is permitted to simultaneously transmit data on both the first and second channels.

10. The device of claim 9, wherein the signal indicates multiple time periods within which the transceiver logic is permitted to simultaneously transmit data on both the first and second channels, each of said time periods associated with a different type of data.

11. The device of claim 1, wherein both the first and second channels comprise bandwidths of at least 20 MHz.

12. The device of claim 1, wherein the device implements the IEEE 802.11 standard.

13. A device, comprising:
circuit logic adapted to transmit data and to receive data on at least one of a control channel and an extension channel;
wherein, if the circuit logic determines that the control channel has been idle for at least a predetermined length of time and that the extension channel has been idle for at least another predetermined length of time, the circuit logic simultaneously transmits data to said another device via both the control and extension channels.

14. The device of claim 13, wherein the control logic transmits said data to said another device upon determining that the control and extension channels are idle for the same period of time.

15. The device of claim 13, wherein the predetermined length of time and the another predetermined length of time are different.

16. The device of claim 13, wherein, if the control logic determines that the control channel is idle for said predetermined length of time, the control logic sends a Request-to-Send (RTS) signal on each of the control channel and the extension channel.

17. The device of claim 16, wherein the control logic sends the RTS signals simultaneously.

18. The device of claim 13, wherein the circuit logic receives a signal which indicates a time period within which the circuit logic is permitted to simultaneously transmit data on both the control and extension channels.

19. The device of claim 18, wherein said signal indicates multiple time periods within which the circuit logic is permitted to simultaneously transmit data on both the control and extension channels, each of said time periods associated with data having different attributes.

20. The device of claim 13, wherein the control channel comprises a 20 MHz-wide channel and the extension channel comprises another 20 MHz-wide channel.

21. The device of claim 13, wherein the device operates in accordance with the IEEE 802.11 standard.

22. A system, comprising:
a first device adapted for wireless communications; and
a second device adapted to transmit data to and receive data from the first device via at least one of a control channel and an extension channel;
wherein, if the second device determines that the control channel has been idle for at least a predetermined amount of time, the second device transmits data to the first device on the control channel;
wherein, if the second device determines that the extension channel has been idle for at least another predetermined amount of time, the second device transmits data to the first device on the extension channel.

23. The system of claim 22, wherein, if said second device determines that the control channel has been idle for said predetermined amount of time, the second device transmits a Request to Send (RTS) signal on the control channel and transmits another RTS signal on the extension channel.

24. The system of claim 22, wherein the second device simultaneously determines whether the control channel has been idle for said predetermined amount of time and whether the extension channel has been idle for said another predetermined amount of time.

25. The system of claim 22, wherein the first device transmits a signal which indicates a time window within which the second device is permitted to simultaneously transmit data on both the control and extension channels.

26. The system of claim 22, wherein said determinations comprise Clear Channel Assessments (CCAs).

27. The system of claim 22, wherein the control channel comprises a 20 MHz-wide channel and the extension channel comprises another 20 MHz-wide channel.

28. The system of claim 22, wherein each of the first and second devices comprises a device selected from the group consisting of a wireless access point (AP) and a personal computer (PC).

29. The system of claim 22, wherein the first and second devices both implement the IEEE 802.11 standard.

30. A method, comprising:
providing a first device and a second device; and
if the first device determines that a control channel has been idle for at least a predetermined length of time and that an extension channel has been idle for at least a different, predetermined length of time, transmitting data from the first device to the second device on both the control channel and on the extension channel.

31. The method of claim 30 further comprising, if the first device determines that the control channel has been idle for said predetermined length of time, sending a Request-to-Send (RTS) signal on the control channel from the first device to the second device and sending another RTS signal on the extension channel from the first device to the second device, said RTS signals sent at the same time.

32. The method of claim 30 further comprising simultaneously determining whether the control channel has been idle for said predetermined length of time and whether the extension channel has been idle for said different predetermined length of time.

33. The method of claim 32, wherein said predetermined length of time equals said different predetermined length of time.

34. The method of claim 30, wherein said determinations comprise Clear Channel Assessments (CCAs).

35. The method of claim 30 further comprising transmitting from the second device to the first device a signal which indicates a time window within which the first device is permitted to simultaneously transmit data on both the control and extension channels.

36. The method of claim 30, wherein each of said control and extension channels comprises a channel having a bandwidth of 20 MHz.

37. The method of claim 30 further comprising operating the first and second devices in accordance with the IEEE 802.11 standard.
